(19) United States
(12) Patent Application Publication
(10) Pub. No.: US 2013/0291807 A1
(43) Pub. Date: Nov. 7, 2013

(54) GAS CONTROL APPARATUS FOR BOILER

(71) Applicants: Chang-Hoon Lee, Busan (KR); Kuk-Chan Moon, Busan (KR); Seong-Jun Kim, Gyeongsangnam-do (KR); Kang-Woo Park, Gyeongsangnam-do (KR)

(72) Inventors: Chang-Hoon Lee, Busan (KR); Kuk-Chan Moon, Busan (KR); Seong-Jun Kim, Gyeongsangnam-do (KR); Kang-Woo Park, Gyeongsangnam-do (KR)

(73) Assignee: UNICK CORPORATION, Busan (KR)

(21) Appl. No.: 13/996,535

(22) PCT Filed: Nov. 29, 2011
(86) PCT No.: PCT/KR2011/009152

§ 371 Date: Jun. 20, 2013

(30) Foreign Application Priority Data
Dec. 21, 2010 (KR) 10-2010-0131647

(51) Int. Cl. F24H 9/20; F16K 31/06

(52) U.S. Cl. CPC F24H 9/2035; F16K 31/06
USPC 122/14.21; 251/129.15

(57) ABSTRACT

Disclosed herein is a gas control apparatus for a boiler, which has a simple structure and enables easy assembly, thus improving productivity and reducing manufacturing costs, therefore enhancing the competitiveness of a product. The gas control apparatus includes a solenoid retracting or ejecting a rod in response to application of power. A cylindrical support unit is coupled to an upper portion of the solenoid and has a suction port and an exhaust port on a side surface and an upper surface thereof, respectively, with a groove being formed along a lower edge of the support unit. A separator is provided between the solenoid and the support unit in such a way that an edge thereof is inserted into the groove. An opening and shutting plate is mounted to an upper end of the rod and opens and shuts the exhaust port of the support unit.

### TECHNICAL FIELD

The present invention relates generally to gas control apparatuses for boilers and, more particularly, to a gas control apparatus for a boiler, which has a simple structure and enables easy assembly, thus improving productivity and reducing manufacturing costs, therefore enhancing the competitiveness of a product.

### BACKGROUND ART

Generally, boilers are the machine which heats water using combustion heat generated by the combustion of fuel, and supplies heated water or vapor to a required place. The boilers are classified into a domestic boiler and an industrial boiler according to a place to be used, and are classified into a small capacity boiler used at home or the like and a large capacity boiler used in a power plant or the like according to a capacity, and are classified into an oil boiler and a gas boiler according to fuel which is used.

Among the above boilers, the gas boiler using gas as the fuel ignites by generating a spark with an ignition transformer and a firing rod, and heats water by burning the supplied gas. Such a gas boiler must control the supply amount of gas in proportion to the amount of air flowing into the gas boiler so as to perfectly burn the gas.

Meanwhile, a gas control apparatus, which regulates the supply amount of gas depending on the amount of air, is electronically controlled to supply a proper amount of gas in proportion to the air inflow amount. That is, a sensor, installed at a suction port into which air flows, detects the air inflow amount and transmits the detected result to a control unit such as a MICOM. The control unit supplies gas to be suitable for a preset mixture ratio, depending on the inflow air amount. For example, if a large amount of air flows into the gas boiler, the supply amount of gas is increased. In contrast, if a small amount of air flows into the gas boiler, the supply amount of gas is reduced. In this way, the mixture ratio of gas with air is kept constant.

### DISCLOSURE OF INVENTION

Technical Problem

Accordingly, the present invention has been made keeping in mind the above problems occurring in the prior art, and an object of the present invention is to provide a gas control apparatus for a boiler, which has a simple structure and enables easy assembly, thus improving productivity and reducing manufacturing costs, therefore enhancing the competitiveness of a product.

Solution to Problem

In order to accomplish the above object, the present invention provides a gas control apparatus for a boiler, including a solenoid retracting or ejecting a rod in response to application of power, a cylindrical support unit coupled to an upper portion of the solenoid and having a suction port and an exhaust port on a side surface and an upper surface thereof, respectively, with a groove being formed along a lower edge of the support unit, a separator provided between the solenoid and the support unit in such a way that an edge thereof is inserted into the groove, and an opening and shutting plate mounted to an upper end of the rod and opening and shutting the exhaust port of the support unit.

Advantageous Effects of Invention

According to the present invention, a gas control apparatus for a boiler is advantageous in that a groove into which an edge of a separator is inserted is formed in a lower end of a support unit, so that the separator can be supported without using a separate holding means. Further, the groove is integrated with the support unit, thus achieving a simple structure and enabling easy assembly. In particular, the simple structure and easy assembly can improve productivity and reduce manufacturing costs, thus enhancing the competitiveness of a product.

### BRIEF DESCRIPTION OF DRAWINGS

The above and other objects, features and advantages of the present invention will be more clearly understood from the following detailed description taken in conjunction with the accompanying drawings, in which:

FIG. 1 is a sectional view showing a gas control apparatus for a boiler according to an embodiment of the present invention;

FIG. 2 is an enlarged view showing portion “A” encircled in FIGS. 1; and

FIG. 3 is a view showing the installed state of the gas control apparatus for the boiler according to the embodiment.

### MODE FOR THE INVENTION

The embodiment of the present invention will be described in detail with reference to the accompanying drawings. Hereinafter, in the description of the embodiment of the present invention, the same reference numerals are used throughout the different drawings to designate the same components.

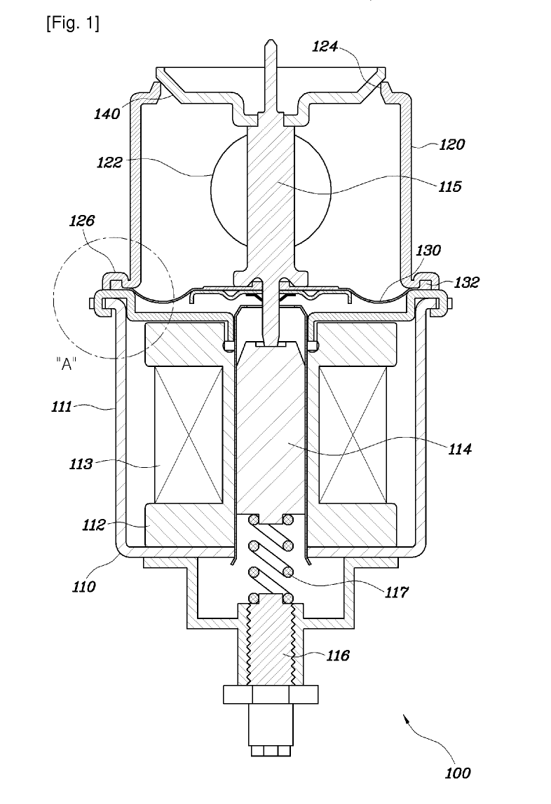

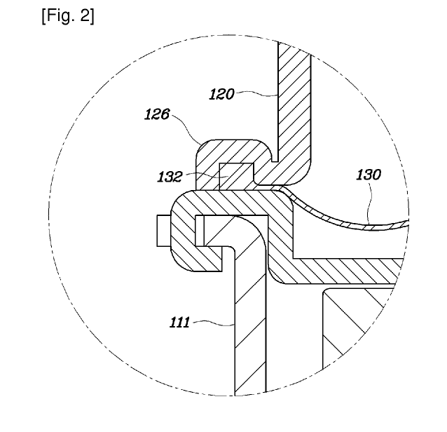

FIG. 1 is a sectional view showing a gas control apparatus for a boiler according to an embodiment of the present invention, and FIG. 2 is an enlarged view showing portion “A” encircled in FIG. 1.

As shown in FIG. 1, the gas control apparatus 100 for the boiler according to the embodiment includes an upper part equipped with a solenoid 110, and a lower part equipped with a support unit 120.

First, the solenoid 110 is the means which retracts or ejects a rod 115 in response to the application of power, thus controlling the flow of gas. The solenoid 110 includes a housing 111, a bobbin 112 which is provided in the housing 111, a coil 113 which is wound around an outer circumferential surface of the bobbin 112, a plunger 114 which is movably provided in the bobbin 112, and a rod 115 which is arranged such that a lower portion thereof comes into contact with an upper end of the plunger 114 and an upper portion thereof is located in the support unit 120.

Among the above parts of the solenoid 110, the bobbin 112 is the insulator which electrically insulates the coil 113 from the plunger 114. The coil 113 wound around the outer circumferential surface of the bobbin 112 is the means which generates a magnetic field when power is applied. Further, the plunger 114 is the movable part which is moved up or down by the magnetic field generated in the coil 113.

Meanwhile, an adjusting screw 116 is mounted to a lower portion of the housing 111, and a spring 117 is provided between an upper end of the adjusting screw 116 and a lower end of the plunger 114 to elastically bias the plunger 114 upwards. Here, the spring 117 functions to rapidly move the plunger 114 upwards when power is applied to the solenoid 110, and the adjusting screw 116 functions to adjust the elasticity of the spring 117 which elastically biases the plunger 114 upwards.

The support unit 120 has the shape of a cylinder of a predetermined length. A suction port 122 is formed in a side surface of the support unit 120 to introduce gas, and an exhaust port 124 is formed in an upper surface of the support unit 120 to discharge gas. Further, a groove 126 is formed in a lower edge of the support unit 120 which is in contact with an upper surface of the solenoid 110, in detail, an upper surface of the housing 111.

The groove 126 functions to hold a separator 130 which is provided between the solenoid 110 and the support unit 120. Such a groove 126 is integrated with the support unit 120, and is bent in an inverted U shape to allow an edge of the separator 130 to be inserted therein. That is, this is formed by pressing an end of the support unit 120 in the inverted U shape.

As described above, if the groove 126 is integrated with the support unit 120, a holding means for holding the separator 130 is not required, thus reducing the number of parts and simplifying a manufacturing process. Therefore, manufacturing costs can be reduced and productivity can be improved, so that the competitiveness of a product is enhanced.

The separator 130 functions to prevent gas passing through the support unit 120 from leaking to the solenoid 110. Such a separator 130 is manufactured of a thin elastic part to be deformable when the solenoid 110 is operated, and is shaped such that an edge 132 thereof is inserted into the groove 126 of the support unit 120.

Meanwhile, an opening and shutting plate 140 is mounted to an upper end of the rod 115 which is retracted or ejected as the solenoid 110 is operated. The opening and shutting plate 140 opens or shuts the exhaust port 124 formed in the upper surface of the support unit 120 when the rod 115 moves up and down, thus controlling the flow of gas. That is, if power is applied to the solenoid 110, the opening and shutting plate 140 moves up along with the rod 115, thus opening the exhaust port 124. If power is cut off, the opening and shutting plate 140 moves down along with the rod 115, thus shutting the exhaust port 124.

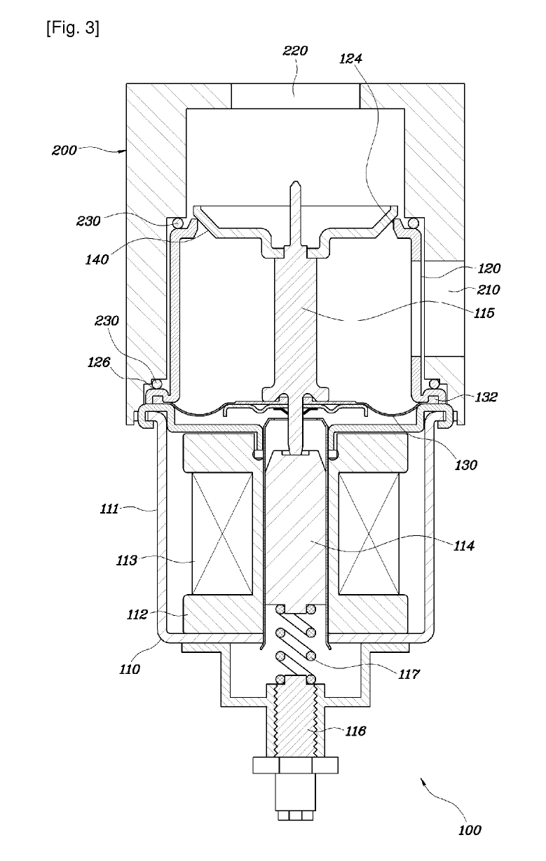

FIG. 3 is a view showing the installed state of the gas control apparatus for the boiler according to the embodiment.

A body 200 in which the gas control apparatus 100 for the boiler according to this embodiment is installed has the shape of a cup which is open at a bottom, that is, the shape of a cup which is turned upside down, and is hollow to permit the support unit 120 to be placed therein. A gas inlet 210 is formed in a side surface of the body 200, and a gas outlet 220 is formed in an upper surface of the body 200. Further, an inner wall of the body 200 is formed in a multi-step structure to allow the support unit 120 to be seated therein. Packing 230 is interposed between the body 200 and the support unit 120.

The operation of the gas control apparatus 100 for the boiler according to this embodiment will be described with reference to FIG. 3.

If power is applied to the solenoid 110, a magnetic field is generated in the coil 113, and the plunger 114 is moved upwards by the magnetic field. The upward movement of the plunger 114 is performed by the elasticity of the spring 117 as well as by the magnetic field in the coil 113.

If the plunger 114 moves upwards as such, the rod 115 coming into contact with the plunger 114 also moves upwards. Thereby, the opening and shutting plate 140 which is in contact with the support unit 120 is spaced apart from the exhaust port 124 and thus opens the exhaust port 124. Thus, gas introduced into the gas inlet 210 of the body 200 passes through the suction port 122, the interior of the support unit 120 and the exhaust port 124 and thereafter is discharged through the gas outlet 220.

In contrast, if power applied to the solenoid 110 is cut off, the magnetic field generated in the coil 113 is eliminated, and thereby the opening and shutting plate 140 moves downwards by the own weight of the rod 115 and the opening and shutting plate 140, thus closing the exhaust port 124. Consequently, the flow of the gas through the support unit 120 is blocked.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A gas control apparatus for a boiler, comprising:
a solenoid retracting or ejecting a rod in response to application of power;
a cylindrical support unit coupled to an upper portion of the solenoid, and having a suction port and an exhaust port on a side surface and an upper surface thereof, respectively, with a groove being formed along a lower edge of the support unit;
a separator provided between the solenoid and the support unit in such a way that an edge thereof is inserted into the groove; and
an opening and shutting plate mounted to an upper end of the rod, and opening and shutting the exhaust port of the support unit.

2. The gas control apparatus as set forth in claim 1, further comprising:
a body coupled to the upper portion of the solenoid in such a way as to receive the support unit therein, and comprising a gas inlet formed at a position corresponding to the suction port, and a gas outlet formed at a position corresponding to the exhaust port.

3. The gas control apparatus as set forth in claim 2, wherein the separator comprises an elastic deformable part.

4. The gas control apparatus as set forth in claim 3, wherein the groove is of an inverted U shape, and the edge of the separator is shaped to be inserted into the groove.

5. The gas control apparatus as set forth in claim 4, wherein the solenoid comprises:
a housing;
a bobbin provided in the housing;
a coil wound around an outer circumferential surface of the bobbin;
a plunger provided in the bobbin in such a way as to move up and down, an upper end of the plunger being in contact with the rod; and
a spring located between the housing and a lower end of the plunger, and elastically biasing the plunger upwards.

6. The gas control apparatus as set forth in claim 1, wherein the separator comprises an elastic deformable part.

7. The gas control apparatus as set forth in claim 6, wherein the groove is of an inverted U shape, and the edge of the separator is shaped to be inserted into the groove.

8. The gas control apparatus as set forth in claim 7, wherein the solenoid comprises:
a housing;
a bobbin provided in the housing;
a coil wound around an outer circumferential surface of the bobbin;
a plunger provided in the bobbin in such a way as to move up and down, an upper end of the plunger being in contact with the rod; and
a spring located between the housing and a lower end of the plunger, and elastically biasing the plunger upwards.
